(19) United States
(12) Patent Application Publication
(10) Pub. No.: US 2018/0236905 A1
(43) Pub. Date: Aug. 23, 2018

(54) CHILD CAR SEAT SYSTEM

(71) Applicant: Recaro Child Safety GmbH & Co. KG, Marktleugast (DE)

(72) Inventors: Stefan GEBHARDT, Weidenberg (DE); Thomas RUFF, Kulmbach (DE)

(73) Assignee: Recaro Child Safety GmbH & Co. KG, Marktleugast (DE)

(21) Appl. No.: 15/753,363

(22) PCT Filed: Aug. 16, 2016
(86) PCT No.: PCT/EP2016/069384

§ 371 Date: Feb. 19, 2018

(30) Foreign Application Priority Data
Aug. 20, 2015 (DE) 10 2015 113 852.2

(51) Int. Cl. B60N 2/28

(52) U.S. Cl. CPC B60N 2/2845; B60N 2/2857; B60N 2/2893; B60N 2/2812; B60N 2/2872

(57) ABSTRACT

A child seat system with at least one child seat configured for an at least substantially upright-sitting child and with an infant carrier configured for a lying-down small child, wherein the infant carrier is configured to be accommodated in the child seat.

The infant carrier is at least substantially implemented by a hard shell.

### STATE OF THE ART

The invention relates to a child seat system according to the preamble of patent claim 1.

A child seat system has already been proposed, with at least one child seat configured for an at least substantially upright-sitting child and with an infant carrier configured for a lying-down small child, wherein the infant carrier is configured to be accommodated in the child seat.

The objective of the invention is in particular to make a generic system with improved characteristics regarding safety available. The objective is achieved, according to the invention, by the features of patent claim 1 while advantageous implementations and further developments of the invention may become apparent by the subclaims.

### Advantages of the Invention

The invention is based on a child seat system with at least one child seat configured for an at least substantially upright-sitting child and with an infant carrier configured for a lying-down small child, wherein the infant carrier is configured to be accommodated in the child seat.

It is proposed that the infant carrier is at least substantially implemented by a hard shell. By a “child seat” is herein in particular a seat for a child to be understood in which a child may be transported in a motor vehicle in a manner that is safe as well as suitable for a child, wherein the child seat is in this context in particular configured for a child from birth up to an age of about four years and/or with a weight of up to 20 kg. “Configured for an at least substantially upright-sitting child” is herein in particular to mean that a child transported in the child seat is sitting in the child seat substantially upright, in a posture in compliance with regulations, wherein it is also conceivable that the child seat is slightly inclined, the child thus sitting in the child seat not completely upright but in a slightly lying position. “Configured” is in particular to mean specifically designed and/or equipped. By an object being configured for a certain function is in particular to be understood that the object fulfills and/or carries out said certain function in at least one application state and/or operating state. By an “infant carrier” is herein in particular a transport shell for a small child to be understood in which a small child may be transported, in particular in a motor vehicle, from birth up to an age of 12 months and/or with a weight of up to 10 kg, in a manner that is safe as well as suitable for a small child, wherein the small child transported in the infant carrier is transported in the infant carrier in a substantially lying-down posture. It is principally also conceivable that the infant carrier is configured for transporting a small child outside a motor vehicle; for example it is conceivable that the infant carrier is connectable to a stroller base frame via a coupling module to thus implement a stroller together with the stroller base frame. “Accommodated in the child seat” is herein in particular to mean arranged in a sitting region of the child seat and encompassed by the child seat at least partly, in particular in the two side regions and in the rear region of the child seat. In particular, the infant carrier is arranged in the sitting region of the child seat in such a way that the infant carrier is laterally encompassed by the child seat at least to a large extent. By “implemented substantially by a hard shell” is herein in particular to be understood that the infant carrier is implemented of a hard shell, i.e. a hard synthetic material or of any other material that is deemed expedient by someone skilled in the art, at least by 50%, preferably at least by 75%. The hard shell herein implements a load-bearing base body of the infant carrier. The infant carrier further comprises a cushion bolstering a lying-down region in which the small child is arranged. Principally it is also conceivable that that the infant carrier comprises reinforcing elements which reinforce the infant carrier and are for this purpose connected to or inserted in the infant carrier. By the “infant carrier being substantially implemented by a hard shell” is herein in particular to be understood that the infant carrier is implemented not only by a cushion or a plurality of cushions. An implementation according to the invention advantageously allows providing a child seat system implementing a particularly advantageous protection for a small child transported in an infant carrier.

It is furthermore proposed that the infant carrier comprises an integrated belt system, which is configured for an en-route safeguarding of the small child. By an “integrated belt system” is herein in particular a belt system to be understood which is configured for a small child, is fixedly connected to the infant carrier and is in particular designed for the safeguarding of small children. The integrated belt system is herein preferably a five-point belt system comprising a plurality of interconnected belts, which may be connected to each other via a belt lock for securing the small child. Herein the internal belt system is in particular embodied differently from an external, vehicle-side belt system which is fixedly integrated in the vehicle and from a belt system of the child seat. An “en-route safeguarding” herein in particular means a securing of the small child in the infant carrier during a ride. The integrated belt system is principally also configured for securing the small child in the infant carrier outside a vehicle as well. This especially advantageously allows implementing the infant carrier for a safeguarding of the small child as well as in particular securing the small child in the infant carrier already outside the motor vehicle, as a result of which a particularly advantageous usage of the child seat is achievable.

It is further proposed that the infant carrier comprises at least one form-fit element which is configured for securing the infant carrier with a corresponding form-fit element of the child seat at least in the sitting direction. By a “form-fit element” is herein in particular an element to be understood which is capable of establishing a form-fit connection by geometrically engaging with a corresponding form-fit element and/or via lying upon a corresponding form-fit element. It is principally also conceivable that the infant carrier is connectable to the child seat via at least one form-fit and/or force-fit element, the form-fit and/or force-fit element ensuring a fixed connection between the child seat and the infant carrier by a combination of a form-fit and a force-fit connection. In this way the infant carrier is couplable with the child seat in a particularly simple and advantageous manner.

Moreover it is proposed that the at least one form-fit element is arranged on a rear side of the infant carrier. By a “rear side of the infant carrier” is herein in particular a side of the infant carrier to be understood which is situated opposite the sitting and/or lying-down surface implementing the infant carrier. The rear side of the infant carrier is herein embodied by the side of the infant carrier that faces rearward in a sitting and/or lying direction of the infant carrier. In a state when accommodated in the child seat, the rear side of the infant carrier faces toward the child seat. This allows arranging the form-fit elements in an especially advantageous manner for coupling with the child seat.

It is also proposed that, for rigidly connecting the infant carrier to the child seat, the at least one form-fit element of the infant carrier is configured to at least partly encompass at least one bolt of the form-fit element of the child seat. “To at least partly encompass” is herein in particular to mean that the form-fit element encompasses the bolt, at least in a coupled state, by at least 50%, preferably by more than 75% and, in a particularly advantageous state, in one direction completely. In this way a particularly advantageous form-fit connection between the infant carrier and the child seat may be made available.

Beyond this it is proposed that the at least one form-fit element is embodied as an ISOFIX connector. By an “ISOFIX connector” is herein in particular a connector to be understood which is standardized according to the norm ISO 13216 and is configured for a connection of child seat systems to a chassis of a motor vehicle. This allows implementing the at least one form-fit element by a standard part.

Furthermore it is proposed that the infant carrier comprises at least two form-fit elements for connecting the infant carrier to the child seat. This allows coupling the infant carrier with the child seat in a particularly secure fashion.

It is moreover proposed that the child seat comprises at least one base seat structure and at least one intermediate shell, which is arranged within the base seat structure. By a “base seat structure” is herein in particular a load-bearing structure of the child seat to be understood, which delimits the child seat at least rearwards and laterally. An “intermediate shell” is herein in particular to mean a structural element in addition to the base seat structure, which is arranged on an inner side of the base seat structure and implements an additional reinforcement, in particular in the lateral regions of the child seat. The intermediate shell is herein arranged between the base seat structure and a cushion of the child seat and/or of the infant carrier. In this way a safety of the child seat is especially advantageously increasable as the intermediate shell provides an additional impact protection.

It is also proposed that the infant carrier comprises at least one further form-fit element, which is arranged on an underside of the infant carrier. By a “further form-fit element” is herein in particular a form-fit element to be understood that differs from the at least one form-fit element. By an “underside of the infant carrier” is herein in particular a side of the infant carrier to be understood on which the infant carrier may be set up in accordance with regulations. In a state when the infant carrier is arranged in the child seat, the underside of the infant carrier faces toward a seat surface of the child seat. This allows especially advantageously securing the infant carrier against rotating in the child seat.

Beyond this it is proposed that the at least one further form-fit element is arranged on a front end of the infant carrier. A “front end of the infant carrier” is herein in particular to mean a front end in the sitting and/or lying direction of the infant carrier. This allows especially advantageously arranging the further form-fit element on the child seat for the purpose of securing the infant carrier.

It is furthermore proposed that the at least one further form-fit element is embodied as a substantially L-shaped hook. A “substantially L-shaped hook” is herein in particular to mean that the form-fit element substantially implements an L-shape, wherein at least two partial regions of the form-fit element are orthogonal to one another. Principally it is also conceivable that the at least two partial regions include an angle differing from 90 degrees by maximally 30 degrees, preferably by no more than 15 degrees and preferentially by maximally 5 degrees. This allows implementing the form-fit element in a particularly simple fashion.

It is further proposed that the child seat comprises at least one further form-fit element, which is implemented correspondingly to the at least one further form-fit element of the infant carrier. By a “form-fit element which is implemented correspondingly” is herein in particular a form-fit element to be understood which is implemented in such a way that it is capable of establishing a form-fit connection with the form-fit element correspondingly to which it is implemented, for the purpose of said two form-fit elements being fixedly connected to one another at least in one direction. The form-fit element which is embodied correspondingly is herein preferably embodied as a recess which the further form-fit element of the infant carrier engages in for implementing a form-fit connection. In this way the child seat may be advantageously implemented for coupling with the infant carrier.

It is also proposed that the at least one further form-fit element of the child seat is embodied as a recess. In this way the further form-fit element of the child seat may be implemented in a particularly advantageous fashion.

The child seat system according to the invention is herein not to be restricted to the application and implementation described above. In particular, to fulfill a functionality herein described, the child seat system according to the invention may comprise a number of respective elements, structural components and units that differs from a number herein mentioned.

### DRAWINGS

Further advantages may become apparent by the following description of the drawings. The drawings show an exemplary embodiment of the invention. The drawings, the description and the claims contain a plurality of features in combination. Someone skilled in the art will purposefully also consider the features separately and will find further expedient combinations.

It is shown in:

FIG. 1 a schematic representation of a child seat system according to the invention, with a seat base, with a child seat and with an infant carrier,

FIG. 2 a schematic representation of the child seat and the seat base,

FIG. 3 a schematic detail view of form-fit elements of the child seat for connecting the infant carrier,

FIG. 4 a schematic side view of the infant carrier,

FIG. 5 a schematic rear view of the infant carrier,

FIG. 6 a schematic detail view of a further form-fit element of the infant carrier, on a front end, and

FIG. 7 a schematic detail view of a further form-fit element of the child seat.

### DESCRIPTION OF THE EXEMPLARY EMBODIMENT

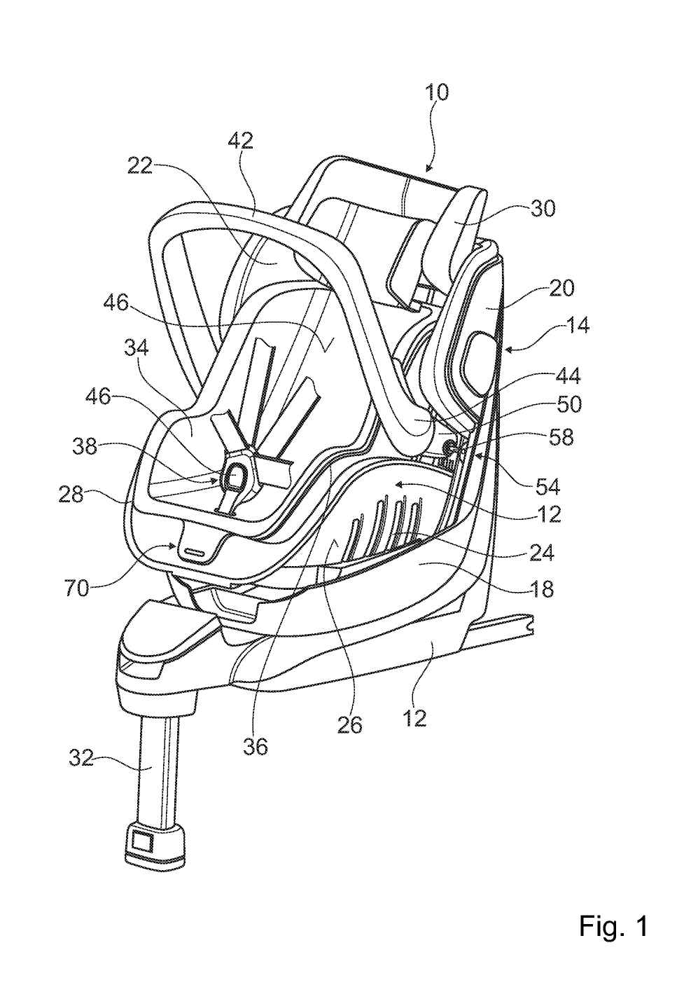

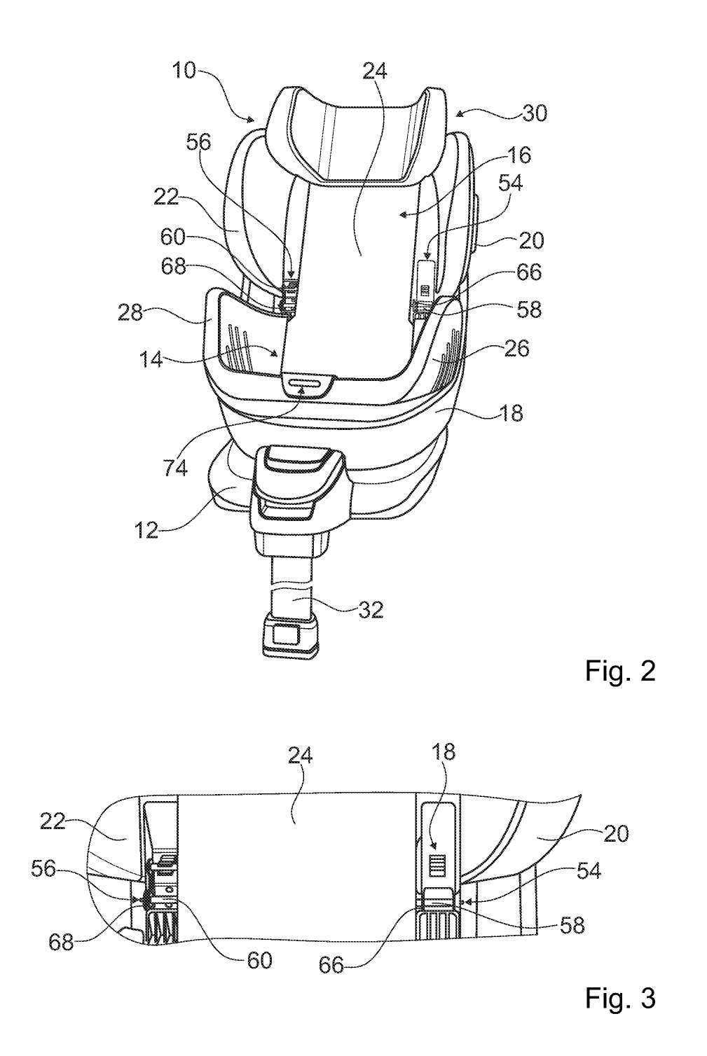

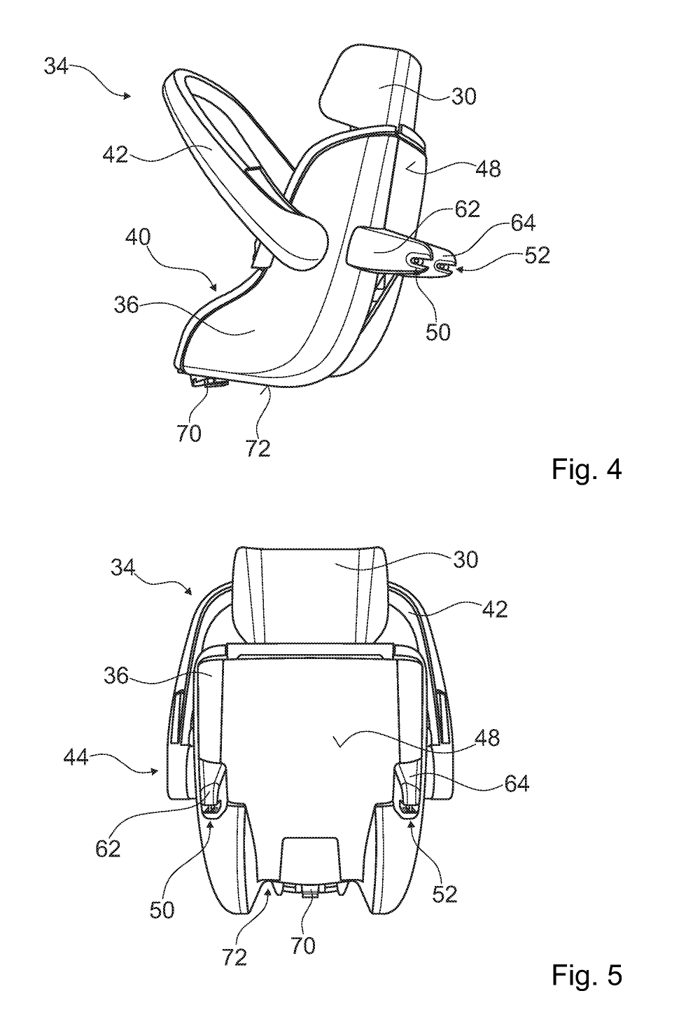

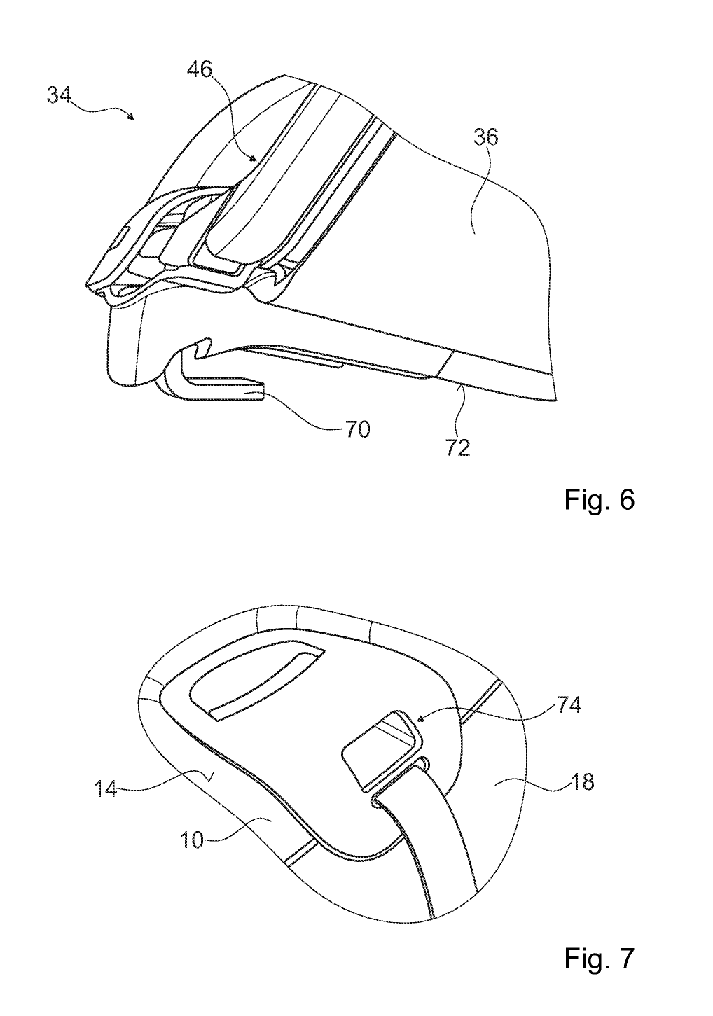

FIGS. 1 to 7 show an embodiment of a child seat system according to the invention. The child seat system is implemented as a motor vehicle child seat system, which is configured to be mounted in a motor vehicle. The child seat system is configured for securely transporting a child or a baby in the motor vehicle. The child seat system comprises a child seat 10. The child seat 10 is configured to transport children from birth up to an age of approximately four years and up to a weight of approximately 20 kg. The child seat 10 is herein configured for a substantially upright-sitting child. In a state when assembled in the motor vehicle, the child seat 10 is fixedly mounted on a motor vehicle seat or on a motor vehicle bench. For the purpose of connecting the child seat 10 in the motor vehicle, the child seat system comprises a seat base 12. The seat base 12 is configured to be directly connected to the motor vehicle seat or the motor vehicle bench of the motor vehicle. The seat base 12 herein comprises fixation means on its rear end, which are configured for a direct coupling with the motor vehicle. The fixation means are herein embodied as ISOFIX connectors. For a connection, correspondingly embodied ISOFIX connectors are arranged in the motor vehicle as fixation means via which the seat base 12 is fixedly connectable to the motor vehicle. Principally it is also conceivable that the seat base 12 is couplable with the motor vehicle via fixation means which are embodied in a different manner deemed expedient by someone skilled in the art. The seat base 12 further comprises a foot 32 on its front end, by which the seat base 12 may be supported on a floor of the motor vehicle. Principally it is also conceivable that the child seat system does not comprise a seat base and the child seat 10 is connected in the motor vehicle directly via fixation means which are embodied accordingly.

The child seat 10 implements a seat bottom 14 and a backrest 16. The seat bottom 14 herein implements a sitting surface allowing a child arranged in the child seat 10 to be seated on. The backrest 16 is arranged on a rear side of the seat bottom 14 and extends from the seat bottom 14 upwards, away from the seat base 12. The child seat 10 comprises a base seat structure 18. The base seat structure 18 is embodied as a shell of the child seat 10. The base seat structure 18 implements a load-bearing structure of the child seat 10. The base seat structure 18 is implemented of a hard plastic material. Principally it is also conceivable that the base seat structure 18 is implemented of a different material that is deemed expedient by someone skilled in the art, e.g. of a fiber-composite material, like in particular a CFRP or a GFRP. Via the base seat structure 18 the child seat 10 is couplable with the seat base 12. In a lower portion the base seat structure 18 implements a connection region for the seat base 12. The base seat structure 18 further implements a rear side of the backrest 16 and implements, in an upper portion, which in the mounted state faces away from the seat base 12, head zones 20, 22 laterally delimiting the child seat 10. The head zones 20, 22 extend from the backrest 16 frontwards in the sitting direction. Herein the head zones 20, 22 in particular encompass a region in which the head of a child sitting in the child seat 10 is arranged. The head zones 20, 22 in particular implement a lateral impact protection in the region of the child seat 10 which the head of the child sitting in the child seat 10 is arranged in. This allows implementing the child seat 10 in a particularly secure fashion.

The child seat 10 comprises an intermediate shell 24. The intermediate shell 24 is arranged within the base seat structure 18. The intermediate shell 24 is arranged on an inner side of the base seat structure 18. Herein the intermediate shell 24 is rigidly connected to the base seat structure 18. The intermediate shell 24 is fixedly connected to the base seat structure 18 via a plurality of connecting elements, which are not shown in detail. The intermediate shell 24 implements the seat bottom 14 of the child seat 10. In particular in a region of the seat bottom 14, the intermediate shell 24 forms lateral walls 26, 28 which delimit the child seat 10 toward an outside in a region of the seat bottom 14. In this way a lateral impact protection is provided in a region of the seat bottom 14 by the walls 26, 28 of the intermediate shell 24. On an upper end of the intermediate shell 24, which faces away from the seat bottom 14, the intermediate shell 24 implements a headrest 30. The headrest 30 is embodied U-shaped and implements, in addition to the head zones 20, 22 of the base seat structure 18, a lateral impact protection for the head of the child sitting in the child seat 10. The child seat 10 further comprises a cushion, which is not shown in detail. The cushion covers the seat bottom 14 and the backrest 16 in a sitting area of the child seat 10. The cushion is herein embodied by a foam material. Principally it is also conceivable that the cushion is embodied by a different soft material.

The child seat system comprises an infant carrier 34. The infant carrier 34 is configured for a small child lying-down. The infant carrier 34 is configured for transporting small children from birth to an age of 12 months and/or with a weight of up to 10 kg. The infant carrier 34 is implemented substantially of a hard shell 36. The hard shell 36 implements a base structure of the infant carrier 34. The hard shell 36 is herein implemented by a hard plastic material. Principally it is also conceivable that the hard shell 36 is implemented of a different material deemed expedient by someone skilled in the art, e.g. a fiber-composite material, e.g. a CFRP or a GFRP. Herein the hard shell 36 is implemented of a plurality of individual elements, which are not designated in detail. Principally it is also conceivable that the hard shell 36 is implemented of one single structural component. On its inner side 38 the infant carrier 34 implements a sitting and/or lying-down surface 40 for the small child. The infant carrier 34 comprises a cushion (not shown in detail), which bolsters the infant carrier 34 in the sitting and/or lying-down surface 40. The infant carrier 34 comprises a carrying handle 42. The carrying handle 42 is configured to facilitate the infant carrier 34 being easily carried by a person. The carrying handle 42 is pivotally connected to the infant carrier 34. Herein the carrying handle 42 is connected to the hard shell 36 of the infant carrier 34. The carrying handle 42 herein extends from a first side of the hard shell 36 to a second side of the hard shell 36. The carrying handle 42 is herein embodied substantially U-shaped. For connecting the carrying handle 42 in an articulated fashion, the hard shell 36 comprises on each side a pivot bearing 44, via which the carrying handle 42 is connected to the hard shell 36 of the infant carrier 34. The infant carrier 34 comprises an integrated belt system 46. The integrated belt system 46 is configured for safeguarding the small child transported in the infant carrier 34. The integrated belt system 46 is embodied as a five-point belt. Principally it is also conceivable that the belt system 46 is embodied as a different belt system deemed expedient by someone skilled in the art. The integrated belt system 46 is fixedly connected to the hard shell 36 of the infant carrier 34. The integrated belt system 46 is herein only schematically depicted in FIG. 1. An implementation of the integrated belt system 46 as well as its fixation to the hard shell 36 of the infant carrier 34 correspond to the usual manner known to someone skilled in the art and will therefore not be described here in detail.

The infant carrier 34 is configured to be accommodated in the child seat 10. For a fixation in the motor vehicle the infant carrier 34 is accommodated in the child seat 10. The infant carrier 34 is herein connected to the child seat 10 fixedly and secure against loss. For a fixed connection to the child seat 10, the infant carrier 34 is arranged in a sitting area of the child seat 10. The infant carrier 34 is introduced into the region within the intermediate shell 24. Herein the infant carrier 34 is set upon the (not shown) cushion of the child seat 10. Principally it is also conceivable that at least a portion of the cushion or the entire cushion is removed for mounting the infant carrier 34 in the child seat 10. Herein, in a state when the infant carrier 34 is coupled with the child seat 10, a rear side 48 of the infant carrier 34 faces toward the child seat 10. For coupling with the child seat 10, the infant carrier 34 comprises a first form-fit element 50 and a second form-fit element 52. The two form-fit elements 50, 52 are configured for a coupling with the child seat 10. For connecting the infant carrier 34 via the form-fit elements 50, 52 of the infant carrier 34, the child seat 10 comprises two correspondingly embodied form-fit elements 54, 56. The form-fit elements 50, 52 of the infant carrier 34 are configured to secure the infant carrier 34 in the sitting direction, together with the correspondingly embodied form-fit elements 54, 56 of the child seat 10. Via the form-fit elements 50, 52 and their connection to the correspondingly embodied form-fit elements 54, 56 of the child seat 10, the infant carrier 34 is secured in the child seat 10 axially, in all directions.

The form-fit elements 50, 52 of the infant carrier 34 are arranged on the rear side 48 of the infant carrier 34. The form-fit elements 50, 52 are configured to respectively engage around a bolt 58, 60 of the form-fit elements 54, 56 of the child seat 10. In a connected state the form-fit elements 50, 52 of the infant carrier 34 completely encompass the respective bolt 58, 60 of the corresponding form-fit element 54, 56 of the child seat 10. As a result of this, in the connected state, the infant carrier 34 is connected to the child seat 10 fixedly and such that it is secured in all directions. The form-fit elements 50, 52 are herein arranged spaced apart from the rear side 48 of the infant carrier 34. On itse rear side 48, the hard shell 36 implements for each form-fit element 50, 52 a projection 62, 64, the form-fit elements 50, 52 being arranged on respective ends of the projections 62, 64, which ends face away from the rear side 48. The form-fit elements 50, 52 comprise latch elements (not shown in detail), which are deflected in a coupling with the form-fit elements 54, 56 of the child seat 10 and snap in behind the bolt 58, 60 of the respective form-fit element 54, 56 for the purpose of establishing a form-fit connection. The two form-fit elements 50, 52 are arranged substantially at a same level of the infant carrier 34. Principally it is however also conceivable that the form-fit elements 50, 52 are arranged at different levels. Herein one form-fit element 50 is arranged on a first side of the infant carrier 34, which is a lefthand side viewed in the sitting direction. The second form-fit element 52 is arranged on a side of the infant carrier 34 which is situated opposite the first side and is, viewed in the sitting direction, a righthand side. The form-fit elements 50, 52 are embodied as ISOFIX connectors. Herein the form-fit elements 50, 52 embodied as ISOFIX connectors are implemented according to ISOFIX connectors known to someone skilled in the art from the prior art and will therefore not be described here in detail. Principally it is also conceivable that the form-fit elements 50, 52 are embodied in a different manner deemed expedient by someone skilled in the art. The form-fit elements 54, 56 of the child seat 10 are implemented by the base seat structure 18 of the child seat 10. The form-fit elements 54, 56 each comprise holding elements 66, 68, which fixedly couple the respective bolt 58, 60 of the form-fit element 54, 56 with the base seat structure 18. The holding elements 66, 68 are herein embodied in a one-part implementation with the base seat structure 18. Principally it is also conceivable that the bolts 58, 60 are also embodied in a one-part implementation with the base seat structure 18. Principally it is also conceivable that the infant carrier 34, and thus the child seat 10 as well, comprise further form-fit elements via which the infant carrier 34 is coupled on its rear side 48 with the child seat 10.

The infant carrier 34 comprises a further form-fit element 70. The further form-fit element 70 is configured for a further coupling with the child seat 10. Herein the further form-fit element 70 is configured to prevent a rotation of the infant carrier 34 in the child seat 10 about an axis extending transversally to the sitting direction. The further form-fit element 70 is arranged on an underside 72 of the infant carrier 34. In a state in which the infant carrier 34 is arranged in the child seat 10, the underside 72 faces toward the seat bottom 14 of the child seat 10. The form-fit element 70 is herein arranged on a front end of the infant carrier 34. The further form-fit element 70 is embodied as an L-shaped hook. On a front end of its seat bottom 14, the child seat 10 comprises a further form-fit element 74, which is implemented correspondingly to the further form-fit element 70 of the infant carrier 34. The further form-fit element 74 of the child seat 10 is embodied as a recess which the further form-fit element 70 of the infant carrier 34 engages in for the purpose of a form-fit connection. In a state when the infant carrier 34 is mounted in the child seat 10, the further form-fit element 70 secures the front end of the infant carrier 34 on the front end of the child seat 10 by form-fit engagement, and is thus capable of preventing a lift-off of the front end of the infant carrier 34 from the child seat 10.

Reference numerals

| | | |
|---|---|---|
| 10 | Kindersitz | child seat |
| 12 | Sitzbasis | seat base |
| 14 | Sitzboden | seat bottom |
| 16 | Ruckenlehne | backrest |
| 18 | Sitzgrundstruktur | base seat structure |
| 20 | Kopfbereich | head zone |
| 22 | Kopfbereich | head zone |
| 24 | Zwischenschale | intermediate shell |
| 26 | Wandung | wall |
| 28 | Wandung | wall |
| 30 | Kopfstutze | headrest |
| 32 | Standfuß | foot |
| 34 | Kinderschale | infant carrier |
| 36 | Hartschale | hard shell |
| 38 | Innenseite | inner side |
| 40 | Sitz-bzw. Liegefläche | sitting and/or lying-down surface |
| 42 | Tragebügel | carrying handles |
| 44 | Schwenklagerung | pivot bearing |
| 46 | Gurtsystem | belt system |
| 48 | Ruckseite | rear side |
| 50 | Formschlusselement | form-fit element |
| 52 | Formschlusselement | form-fit element |
| 54 | Formschlusselement | form-fit element |
| 56 | Formschlusselement | form-fit element |
| 58 | Bolzen | bolt |
| 60 | Bolzen | bolt |
| 62 | Erhebung | projection |
| 64 | Erhebung | projection |
| 66 | Halteelement | holding element |
| 68 | Halteelement | holding element |
| 70 | Formschlusselement | form-fit element |
| 72 | Unterseite | underside |
| 74 | Formschlusselement | form-fit element |

1. A child seat system with at least one child seat configured for an at least substantially upright-sitting child and with an infant carrier configured for a lying-down small child, wherein the infant carrier is configured to be accommodated in the child seat, wherein the infant carrier is at least substantially implemented by a hard shell.

2. The child seat system according to claim 1, wherein the infant carrier comprises an integrated belt system, which is configured for an en-route safeguarding of the small child.

3. The child seat system according to claim 1, wherein the infant carrier comprises at least one form-fit element which is configured for securing the infant carrier with a corresponding form-fit element of the child seat at least in the sitting direction.

4. The child seat system according to claim 3, wherein the at least one form-fit element is arranged on a rear side of the infant carrier.

5. The child seat system at least according to claim 3, wherein, for rigidly connecting the infant carrier to the child seat, the at least one form-fit element is configured to at least partly encompass a bolt of the other form-fit element.

6. The child seat system at least according to claim 3, wherein the at least one form-fit element is embodied as an ISOFIX connector.

7. The child seat system at least according to claim 3, wherein the infant carrier comprises at least two form-fit elements for connecting the infant carrier to the child seat.

8. The child seat system according to claim 1, wherein the infant carrier comprises at least one further form-fit element, which is arranged on an underside of the infant carrier.

9. The child seat system according to claim 8, wherein the at least one further form-fit element is arranged on a front end of the infant carrier.

10. The child seat system at least according to claim 8 wherein the at least one further form-fit element is embodied as a substantially L-shaped hook.

11. The child seat system at least according to claim 8, wherein the child seat comprises at least one further form-fit element, which is implemented correspondingly to the at least one further form-fit element of the infant carrier.

12. The child seat system according to claim 11, wherein the at least one further form-fit element of the child seat is embodied as a recess.

13. The child seat system according to claim 1, wherein the child seat comprises at least one base seat structure and at least one intermediate shell, which is arranged within the base seat structure.

14. A child seat according to claim 1.

15. An infant carrier according to claim 1.
